(19) United States
(12) Patent Application Publication
(10) Pub. No.: US 2005/0122224 A1
(43) Pub. Date: Jun. 9, 2005

(54) Electronic fencing for children and to warn of approach of undesirable individuals

(76) Inventor: Larry Lunz, Fort Wayne, IN (US)

Correspondence Address: George R. Royer;Suite 416, 316 N. Michigan Street, Toledo, OH, 43624, US

(21) Appl. No.: 10/728,146

(22) Filed: Dec. 4, 2003

(51) Int. Cl. G08B 23/00

(52) U.S. Cl. 340/573.4; 340/686.6

(57) ABSTRACT

The subject invention is an electronic fence adapted to warn of the undesired wanderings of young children and/or the approach of undesirable individuals to include means to immediately warn others in a restricted home or other area when an undesirable individual approaches a restricted area; such overall structure including pluralities of boundary markers with electronically based detection mans, a receiver device capable of receiving a plurality of radio signals, and means to display or project the activation of a detection device that further indicates which detection device has been activated in order that the observer can determine that a child or an individual is transgressing a given boundary limit and the area where such transgression is occurring.

### DISCUSSION OF BACKGROUND OF THE INVENTION AND RELEVANT PRIOR ART

The area of this application pertains to an electronic fencing structure for warning of the approach or ingress of undesirable individuals into a given area, generally a restricted area around the home or other restricted area such as a park, etc., with means to alert an individual when such an individual moves beyond the designated boundary limit. As such, the subject application is conceived as a means to ensure the safety others, such as children in the restricted area to keep children or others protected from the undesirable individual. For example, in some areas it is difficult to erect fences around a home, or zoning laws may prohibit same. In such instances, other means are needed to keep undesirable out of such area for protection purposes.

The subject application herein also pertains to an electronic fencing structure for keeping children in a safe area such as a limited area around a home, with means to alert an individual when a child moves beyond the designated boundary and just where the child is relative to the boundary area. As such, the subject device is conceived as a means to ensure the safety of a child in an area where there are no enclosing fences to keep a child confined. For example, in some areas it is difficult to erect fences around a home, or zoning laws may prohibit same. In such instances, other means are needed to keep a child in a confined area.

In this respect, electronic fences are not new, and are especially used for pets. Such latter devices include electronic means to dispose around a prescribed zone, such electronic means having a means to activate a sensor on an animal whenever the animal moves beyond or up to an electronically controlled boundary. In animal orientated electronic fencing the sensor worn by the animal provides, when activated, a minimal electric shock is administered to the animal as a warning, to retard the animal's movement outside the designated zone..

Obviously, such electrical shock means used would not be appropriate or suitable for humans. Consequently, there is an alternative electronic method needed for helping to keep undesirables out of a given area. Thus, in home areas that do not have enclosed fencing, means are needed other than electrical shock techniques for detection and warning when an undesirable away from a designated safe area. Such means could comprise electronic structures to constantly monitor the ingress of individuals. The structural aspects of this invention may be used for other purposes, and may be used as a means to locate individuals at any time in a given area, not just an area surrounding a home area.

It is to be noted in this regard, that electronic fencing as presently used for animals does not have to detect the precise location of the animal, as such system has no extrinsic monitoring, and it comprises generally placing a continuously loop of wire buried underground that has a constant signal transmitted therethrough. The monitor on the animal receives such signal and activates a warning device to the animal if it strays too close or on the boundary formed by the wire. Such a system does not provide a means to locate or warn of an individuals location relative to the perimeter of such designated protected area, and such a system is needed for more effective security of potential victims.

For the reasons stated above, the subject invention is conceived and the following object of the invention are conceived accordingly.

### OBJECTS

It is an object of the subject invention to provide an electronic warning fencing measure.

Still another object of the subject invention is to provide an improved apparatus to provide security for individuals in a protected area.

Another object of the subject invention is to provide an improved means to maintain constant surveillance of a protected area against the ingress of undesirable individuals into a protected area.

Yet another object of the subject invention is to provide an improved arrangement helping to keep a child or others protected in a given area inside or outside a home;

Yet another object of the subject invention is to provide a device to protect children in a safe area from the intrusions of unwanted individuals in a given area;

A future object of the subject invention is to provide an improved structure for electronically monitoring individuals as to a given area around a home;

It is an object of the subject invention to provide an electronic fencing measure for individuals approaching a given area.

Another object of the subject invention is to provide an improved means to maintain constant surveillance as to the location of undesirable individuals in a given area;

Yet another object of the subject invention is to provide an improved arrangement helping to keep children safe in a given area inside or outside a home;

An object of the subject inventions to provide a device to protect the children and help monitor an individual's presence in a given area;

A further object of the subject invention is to provide an improved structure for electronically surveying a given area around a home;

Other and further objects of the subject invention will become apparent from a reading of the description taken in conjunction with the claims.

### BRIEF DESCRIPTION OF THE DRAWINGS

FIG. 1 is a schematic view for a top elevational view of a potential electronic arrangement for a given area.

FIG. 2 is a schematic view of the electronic means used in conjunction with the subject.

FIG. 3 is a schematic view of the system, with the individuals shown.

### DESCRIPTION OF GENERAL EMBODIMENT AND SUMMARY OF INVENTION

The subject invention is an electronic fence adapted to include means to immediately warn of the intrusion of undesirable individuals entering a designated area and the location of where the individual may be; such overall structure including plurality of boundary markers with electronically based detection means, a receiver device capable of receiving a plurality of radio signals, and means to display or project the activation of a detection device that further indicates which particular detection device has been activated in order that the observer can determine that someone is transgressing in a given boundary limit and the area where this is occurring.

The subject application herein also pertains to an electronic fencing structure for keeping children in a safe area such as a limited area around a home, with means to alert an individual when a child moves beyond the designated boundary and just where the child is relative to the boundary area. As such, the subject device is conceived as a means to ensure the safety of a child in an area where there are no enclosing fences to keep a child confined. For example, in some areas it is difficult to erect fences around a home, or zoning laws may prohibit same. In such instances, other means are needed to keep a child in a confined area.

In summary, the subject invention is an electronically based system to keep track of individuals relative in a given zone arbitrarily debarked to constantly monitor whether undesirables enter or are about to enter a given zone, thereby alerting one of the need to proceed to the area and stop the continued movement of the individual into the zone. For this purpose, the general embodiment of the subject invention contemplates one or more electronic sensors, preferably radio-based transmitter or receivers located in a spaced or unitary manner around the perimeter of the given zone set by the responsible adult. These electronic sensors would be generally spaced from one another, preferably but not essentially, so that when one is wearing an appropriate weak signal transmitter or receiver (to be placed on an undesirable individual by a police or governmental agency) that stays and then moves with the individual, and when the individual moves between two adjoining sensors one or two sensors will be activated. When both such sensors are activated, a signal will be relayed to an electronic monitor in the vicinity of the adult to indicate specifically the location of the two sensors activated by the undesirable individual so that the individual is known to be in the general area where the individual is then located and approaching. This will permit the adult to proceed immediately to a specific area to stop the undesirable individual.

### H. Description of Preferred Embodiment

In describing one or more specific preferred embodiments of the subject invention, it is to be stressed, in this regard, that such preferred embodiments, as described, shall not limit the scope of the subject invention, as set forth in the claims hereto.

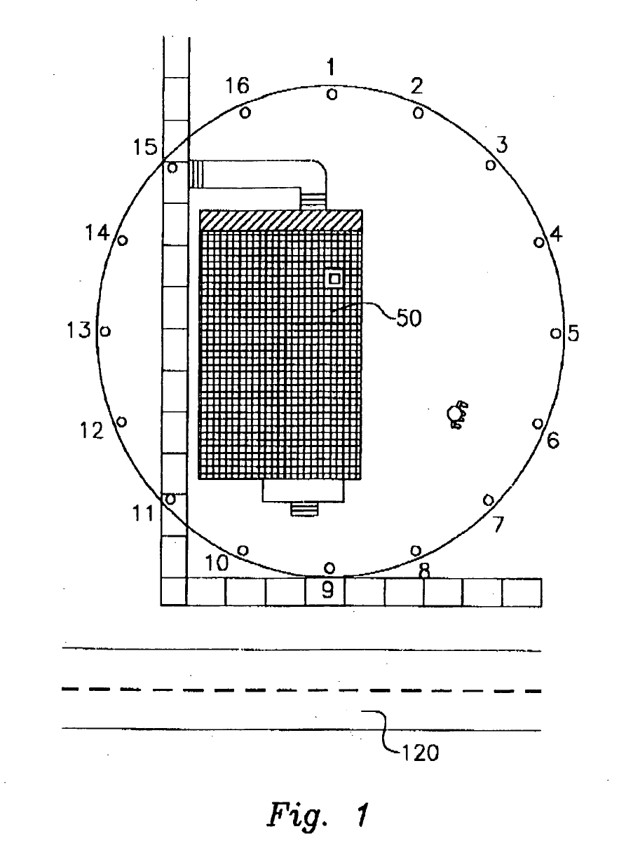

Referring now to the drawings in which a preferred embodiment of the subject invention is shown, with attention first being directed to FIG. 1 of the drawings. As seen in FIG. 1 of the drawings, a schematic upper elevational view of a home 50 is shown, such home having a roof 60, a front porch 70, leading to a front door, not shown, for egress or ingress into or from the interior 75 of the home. Also seen in FIG. 1 is a back porch 80, also leading to a rear door, not shown, A front walkway 90, a side walkway 100 and a rear walkway 110 are disposed around home 50. Additionally represented in FIG. 1 is a frontally disposed roadway 120 on which the home is located. None of these stated features or the surrounding walkway for driveway features are critical to implementation of the subject invention and are only set forth as exemplary features on which the subject invention can be based. It is stressed that the foregoing affixed features of home 50 and the surrounding described improvements are not part of the inventive concept described herein, but are solely shown as exemplary attributes of a home and surrounding area to demonstrate how the specific attributes of the subject invention may be positioned to achieve intended results herein.

Further, as depicted in FIG. 1 is an arbitrarily positioned boundary area 130 which having an outer perimeter in which young children may be located for play and safety purposes. The boundary area 130 need not show a surrounding conventional fence, which for one or more reasons cannot be placed around a home for various reasons. It is to be noted that the subject invention can be implemented irrespective of whether a boundary fence is deployed or not around the home 50. However, the subject invention can be utilized irrespective of whether a surrounding fence is in place or not.

In lieu of a conventional fence, however, the subject concept uses an electronic fence mechanism that uses a series of electronic sensors 1, 2, 3, 4, 5, 6, 7, 8, 9, 10, 11, 12, 13, 14, 15, and 16 disposed strategically around the outer perimeter 150 defining the boundary 130, as enclosed by such electronic sensor otherwise referred to as a restricted zone. The number of sensors displayed may vary as needed to complete a perimeter-like arrangement around the boundary area 130. These electronic sensors 1,2, 3, 4, 5, 6, 7, 8, 9, 10, 11 at 13, 14, 15 and 16 can have either radio activated receivers or transmitters depending correspondingly and reciprocally on whether the apparatus placed on the child is a radio transmitter or receivers. In the preferred embodiment of the subject invention the electronic sensors 1, 2, 3, 4, 5, 6, 7, 8, 9, 10, 11, 12, 13, 14, 15 are structured as electronic receivers adapted to receive radio signals from a low power transmitter having a range of a limited number of feet, as more fully discussed below. Moreover, the number of such electronic sensors may vary in number from the number sequence above, as being more or less than the number sequence above.

In the preferred embodiment the electronic sensors 1, 2, 3, 4, 5, 6, 7, 8, 9, 10, 11, 12, 13, 14, 15 are adapted to react to the same radio frequency signal; however, this aspect is not essential to the subject invention. Specifically, each sensor may be equipped to adapt to a different signal. However, for purposes of efficiently implementary the subject invention, it is preferable that each electronic sensor 1, 2, 3, . . . 16 be adapted to react to a single frequency.

As a result of this latter aspect, a single frequency transmitter 300 to be worn by an individual 140 in the boundary area 130 can be utilized to activate any one of the electronic sensors 1, 2, 3, 4, 5, 6, 7, 8, 9, 10, 11, 12, 13, 14, 15. These aspects will be set forth in more detail below. This transmitter 300 may be assigned and maintained on an individual having a record of certain type of crimes, such as sex crimes, and this mandatory placement may be by court order or otherwise.

At this point, it must be emphasized that any number of electronic arrangements may be used in this regard. For example, the electronic sensors 1, 2, 3, 4, 5, 6, 7, 8, 9, 10, 11, 12, 13, 14, 15 can have electronically transmitters dispensed through a unit to be worn by the individual being a electronic receiver that will be receptive to a signal generated from any of the electronic transmitters. For this purpose the electronic transmitters will generate a continuous signal when the overall detection system is activated. In one embodiment, each transmitter will have a different signal frequency, with the receiver worn by the individual being sensitive to each different signal. On the other hand, the electronic sensors, if structured as transmitters, can have one common frequency to generate, and a sensor to be worn by the individual can be thus sensitive to only one such signal. Other electronic signally arrangements can be used in this regard, as contradistinguished from those described above.

As stated above, in the preferred embodiment of the subject invention, the electronic sensors 1, 2, 3, 4, 5,6, 7, 8, 9, 10, 11, 12, 13, 14, 15 are adapted to be electronic receivers and therefore the remainder of the discussion will be focused on such a structural arrangement. To this end, each electronic sensor is preferably, but not critically, affixed to a vertical pole 210A, 210B, 210C, 210D, 200E . . . 210P affixed into the ground with the sensors, 2, 3, . . . 16 affixed to each pole respectively. However, the sensors 1, 2, 3, 4, 5, 6, 7, 8, 9, 10, 11, 12, 13, 14, 15 can be positioned at ground level, or the sensors can be placed below ground level, or any other position so long as they can adequately receive the necessary signal.

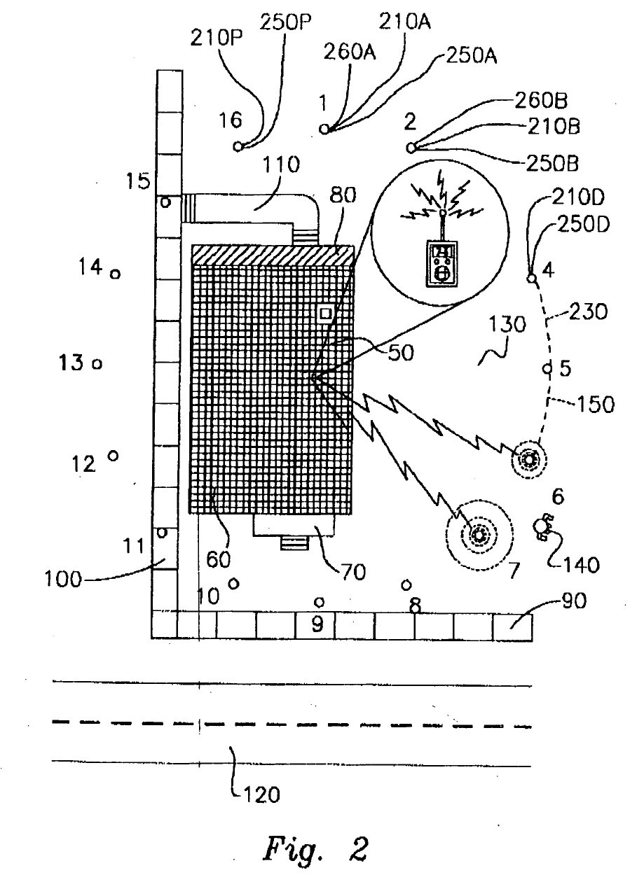

In the embodiment shown in FIG. 1 and FIG. 2, the electronic sensors 1, 2, 3, 4, 5, 6, 7, 8, 9, 10, 11, 12, 13, 14, 15, 16 are placed strategically around the perimeter 230 of the boundary area 130, as seen. It is desirable but not essential that each of the sensors 1, 2, 3, 4, 5, 6, 7, 8, 9, 10, 11, 12, 13, 14, 15 be spaced apart from each other in an equal distance spacing on the perimeter 230, as generally shown in FIG. 1 and FIG. 2. Moreover, as seen the perimeter 230, around the home 50 is shown as being rounded; however, the perimeter of the protective zone or area boundary 130 can be any shape other than round dependent on the circumstances of the particular home structure and precise needs and wishes of the responsible individuals involved.

Furthermore, it is not essential that the perimeter 230 surround the home 50, and as more particularly described below, the system described herein can be deployed throughout neighborhoods and small towns, or around parks, playgrounds, or ball fields, as an example.

Each sensor 1, 2, 3, 4, 5, 6, 7, 8, 9, 10, 11, 12, 13, 14, 15 as described is comprised of an electronic receiver in the preferred embodiment being described herein. Thus each sensor 1, 2, 3, 4, 5, 6, 7, 8, 9, 10, 11, 12, 13, 14, 15 will be correspondingly equipped with a radio receiver 250A, 250B, 250C, . . . 250P. These latter radio receivers 250A, 250B, 250C, . . . 250P will be, as previously stated, adapted to receive and react to a single frequency. Interfaced to each receiver 250A, 250B, 250C,, . . . 250P is a separate transmitter 260A, 260B, 260C, . . . 260P. Alternately stated, a separate transmitter can be integrated into the same unit as the receiver unit. In the preferred embodiment of the subject invention, as an example for each of the sensors 1, 2, 3, 4, 5, 6, 7, 8, 9, 10, 11, 12, 13, 14, 15, as seen in FIG. 4, which is the circuitry schematics for receiver 250A, such receiver has interconnected thereto a circuit connector 270 A. The circuit connector 270A feeds into the interfaced transmitter 260A and relays an electric signal to transmitter 260A when the receiver 250A is activated by a signal from the individuals transmitter 300. When the transmitter 260A is activated by such signal, it will emit a radio frequency signal which will be received by a central radio receiver 290 at a central source accessible to the monitoring adult. For this purpose it is preferable that each interfaced transmitter 260A, 260B, 260C, . . . 260P have a different frequency from the others. This latter transmitted signal differentiation will enable the receiving monitor to detect which of the sixteen sensors 1, 2, 3, 4, 5, 6, 7, 8, 9, 10, 11, 12, 13, 14, 15 received a transmitted signal from the individual's transmitter, or more specifically, which of the electronic sensors 1, 2, 3, 4, 5, 6, 7, 8, 9, 10, 11, 12, 13, 14, 15, 16 have been activated and is relaying a signal to the central receiver 290, as more filly discussed below.

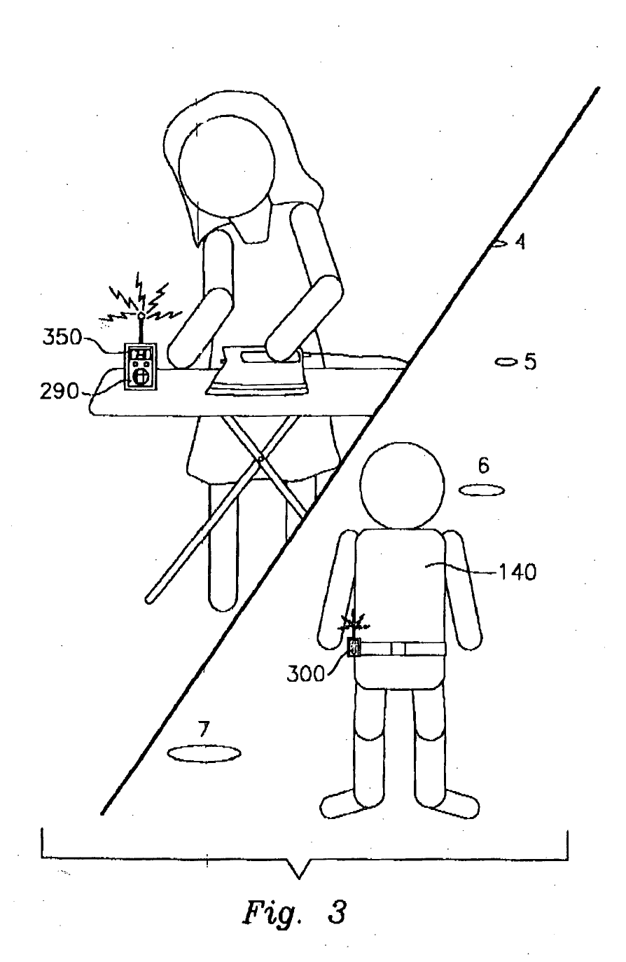

In the preferred embodiment, the additional elements of the invention herein include a transmitter 300 worn by the individual 140, as indicated above, and a central receiver 290 used by the monitoring adult 330. As seen in FIG. 2 and FIG. 3 the central receiver 290 used by the responsible adult will preferably, but not absolutely essential, be a portable radio receiver having means to receive and to differentially identify the separate signals transmitted by the transmitter 260A, 260B, 260C, . . . 260P interfaced on each sensor 1, 2, 3, . . . 16. The central receiver 290 will also preferably have a monitor screen to display in numerical form which the sensor transmitters 260A, 260B, 260C, . . . 260P is generating a signal to the central receiver 290. Thus as an example, if sensor number 6 is activated by the individual's transmitter 300 it will cause transmitter 260F to transmit its' unique signal relative to all the other transmitters 260A, 260B, 260C, . . . 260P in the system, and activate the central receiver 290 to be activated to in turn display the digit 6 on the display screen 350 on such central receiver 290. If the individual transmitter activates two sensors, such as sensors 6 and 7, it will display both digits 6 and 7 on the display screen 350, as represented in FIG. 3.

It is to be stressed at this point that the individual transmitter 300 will have a limited distance range of signal generation, which would preferably be approximately be a marginal distance over one half the distance between the spaced sensors. The reason for this limited signal strength is that the one essential purpose and function of this system herein is to identify which location of the perimeter at which the undesirable individual is about to transgress. Thus if an individual approaches midway between sensors 6 and 7 on the perimeter of the protected zone 130 only sensors 6 and 7 will be activated, since the range of the adult's transmitter will be only a minimal distance over the half distance between sensors 6 and 7. If the adult is closer to sensor 6 than sensor 7, it will activate only sensor 6. In any event at least one or possible two sensors will be activated by the adult's transmitter 300 which in turn will cause that particular sensor transmitter to relay its' differential radio signal to the central monitoring receiver 290. In turn the latter central receiver 290 will display in digit form on the screen 350 which sensor is activated, thus indicating where the adult is on the perimeter zone 130.

Once a digit is shown on the screen, it can cause activation a sound signal to alert the monitoring individual of the activation of central receiver 290. The responsible adult can read the digit or digits on the screen 350 and identify specifically where the adult is moving in on the perimeter.

As seen in FIG. 2 and FIG. 3 the central receiver 290 used by the monitoring individual will preferably, but not absolutely essential, be a portable radio receiver having means to receive and to differentially identify the separate signals transmitted by the transmitter 260A, 260B, 260C, . . . 260P interfaced on each sensor 4, 5, 6, 7, 8, 9, 10, 11, 12, 13, 14, 15, 16. The central receiver 290 will also preferably have a monitor screen to display in numerical form which the sensor transmitters 260A, 260B, 260C, . . . 260P is generating a signal to the central receiver 290. Thus as an example, if sensor number 6 is activated by the child's transmitter 300 it will cause transmitter 260F to transmit its unique signal relative to all the other transmitters 260A, 260B, 260C, . . . 260P in the system, and activate the central receiver 290 to be activated to in turn display the digit 6 on the display screen 350 on such central receiver 290. If the child's transmitter activates transmitter activates two sensors, such as sensors 6 and 7, it will display both digits 6 and 7 on the display screen 350, as represented in FIG. 3.

It is to be stressed at this point that the child's transmitter 300 will have a limited distance range of signal generation, which would preferably be approximately be a marginal distance over one half the distance between the spaced sensors. The reason for this limited signal strength is that the one essential purpose and function of this system herein is to identify which location of the perimeter at which the child is about to transgress. Thus if a child approaches midway between sensors 6 and 7 on the perimeter of the protected zone 130 only sensors 6 and 7 will be activated, since the range of the child's transmitter will be only a minimal distance over the half distance between sensors 6 and 7. If the child is closer to sensor 6 than sensor 7, it will activate only sensor 6. In any event at least one or possibly two sensors will e activated by the child's transmitter 300 which in turn will cause that particular sensor transmitter to relay its differential radio signal to the central monitoring receiver 290. In turn the latter central receiver 290 will display in digit form on the screen 350 which sensor is activated, thus indicating where the chide is on the perimeter zone 130. Once a digit is shown on the screen, it can cause activation a sound signal to alert the monitoring individual of the activation of central receiver 290. The adult can read the digit or digits on the screen 350 and identify specifically where the child is moving on the perimeter. In some embodiments, the child's receiver may have affixed thereto a warning signal or voice recording to alert the child to stop or turn around. There is no electric shock involved in this system.

In addition to the foregoing embodiments, additional attributes can be added to enhance the control and security oversight of the subject invention. One such enhanced feature is the addition of a telephonic connection to the local “911” emergency call center. More specifically, interconnected to each of the electronic sensors, 2, 3, 4, 5, 6, 7, 8, 9, 10, 11, 12, 13, 14, 15 is a separate telephonic sequentially device that initiates a direct call to a “911” operator with a recorded message providing the address of the call and that either an undesirable intruder is entering into the protected zone or conversely that a child is leaving the zone. This will save an otherwise distracted parent from the effort of making an immediate call for such purpose.

1. An electronic fence structure to monitor an undesirable individual in a given geographic zone comprising of:
(a) a geographical zone in which for safety purposes, said geographic zone having an outer perimeter enclosing said zone;
(b) a plurality of electronic sensors dispersed around the perimeter of said zone, each of said electronic sensors having an electronic radio receiver sensitive to a radio frequency signal; and
(c) an electronic transmitter means disposed on said individual, said electronic transmitter means having means to transfer a signal of location and range.
(d) secondary electronic transmitter means on each of the electronic sensors, with each said transmitter being electronically interconnected to the electronic receiver on said electronic sensor, with each said secondary transmitter on said electronic sensors having a different sending frequency than the other said secondary transmitters;
(e) primary electronic transmitter means worn by said individual which said primary transmitter has a radio frequency that can be relayed to each radio receiver on each electronic sensor;
(f) secondary radio receiver means held by a monitoring adult to detect a signal from a radio transmitter on one or more of the electronic sensors.

2. An electronic fence structure to monitor a child's presence in a given geographic zone comprising of:
(a) A geographic zone in which a child is to be contained for safety purposes, said geographic zone having an outer perimeter enclosing said zone;
(b) A plurality of electronic sensors dispersed around the perimeter of said zone, each of said electronic sensors having an electronic radio receiver sensitive to a radio frequency signal; and
(c) secondary electronic transmitter means on each of the electronic sensors, with each said transmitter being electronically interconnected to the electronic receiver on said electronic sensor, with each said secondary transmitter on said electronic sensors having a different sending frequency that the other said secondary transmitters;
(d) primary electronic transmitter means worn by the child in the zone, with said primary transmitter having a radio frequency that can be relayed to each radio receiver on each electronic sensor;
(e) secondary radio receiver means held by a monitoring adult to detect a signal from a radio transmitter on one or more of the electronic sensor.

3. An electronic fence structure to monitor an individuals presence in a given spatial area comprising of:
(a) A spatial area in which said individual is to be confined for safety purposes, said area having an outer perimeter enclosing said area;
(b) A plurality of electronic sensors dispersed around the perimeter of said area, each of said electronic sensors having an electronic radio receiver sensitive to a radio frequency signal; and
(c) Secondary electronic transmitter means on each of the electronic sensors, with each said transmitter being electronically interconnected to the electronic receiver on said electronic sensor, with each said secondary transmitter on each of said electronic sensors having a different sending frequency than the other said secondary transmitters;
(d) Primary electronic transmitter means worn by said individual in said area which said primary transmitter has a radio frequency that can be relayed to each radio receiver on each electronic sensor:
(e) Secondary radio receiver means used by a second individual to detect a signal from a radio transmitter on one or more of said electronic sensors.
(f) telephonic means connected to each of said sensors to relay a telephonic message to a central emergency center for immediate police and whenever any of said sensors are activated.
